(19) United States
(12) Patent Application Publication
(10) Pub. No.: US 2017/0153807 A1
(43) Pub. Date: Jun. 1, 2017

(54) OPERATIONAL METHOD FOR TERMINAL DEVICE, AND TERMINAL DEVICE

(71) Applicants: LE HOLDINGS (BEIJING) CO., LTD., Beijing (CN); LE SHI INTERNET INFORMATION & TECHNOLOGY CORP., BEIJNG, Beijing (CN)

(72) Inventor: Lijun DUAN, Beijing (CN)

(73) Assignees: LE HOLDINGS (BEIJING) CO., LTD., Beijing (CN); LE SHI INTERNET INFORMATION & TECHNOLOGY CORP., BEIJNG, Beijing (CN)

(21) Appl. No.: 15/241,872

(22) Filed: Aug. 19, 2016

Related U.S. Application Data
(63) Continuation of application No. PCT/CN2016/089509, filed on Jul. 10, 2016.

(30) Foreign Application Priority Data
Dec. 1, 2015 (CN) 2015108690419

(51) Int. Cl. G06F 3/0488; G06F 3/041; G06F 3/0482

(52) U.S. Cl. CPC G06F 3/04883; G06F 3/0482; G06F 3/0414

(57) ABSTRACT

Certain embodiments of the present disclosure provide an operational method for a terminal device, and a terminal device. The operational method includes: presenting information of target classification items according to an instruction of presenting the target classification items; and acquiring item information corresponding to the first classification item, in response to a first press operation of a user on a first classification item in the target classification items, and presenting the item information in a form of a floating window.

### CROSS-REFERENCE TO RELATED APPLICATIONS

This application is a continuation of International Application No. PCT/CN2016/089509 with an international filing date of Jul. 10, 2016, which is based on and claims priority to Chinese Patent Application No. 201510869041.9, filed with the Chinese Patent Office on Dec. 1, 2015, the entire contents of all of which are incorporated herein by reference.

### TECHNICAL FIELD

The present disclosure relates generally to computer technologies, and in particular, to an operational method for a terminal device, and a terminal device.

### BACKGROUND

With the continuous development of network technologies and information technologies, acquiring information though the Internet has become one of the important means for people to acquire information. For convenient management of information, multiple classification items may be set for information. However, how to rapidly browse item information in each classification item, or how to find target item information from each classification item becomes a problem that urgently needs to be solved.

Resource websites generally provide multiple classification items. Taking TV dramas as an example, classification items may include war dramas, city comedies, historical dramas and the like. When a user searches for certain information, a classification item is selected from multiple classification items provided by a resource website and when the classification item is clicked, a terminal device presents the item information (for example, the name of a TV drama, etc.) included in the classification item. Then, the user searches for the needed information therefrom, and if the needed information is not found, the user returns to the page with the multiple classification items by using the terminal device, and again selects other classification items from the multiple classification items. The terminal device executes the same processing as the foregoing described until the user finds the needed information.

However, when a user searches for certain information, each classification item needs to be opened respectively for searching. Furthermore, there may be multilevel classification items for information classification. Consequently, the user needs to frequently tap the operational classification items to enter into the corresponding classification items to view item information, which lowers operational experience of the user.

### SUMMARY

An objective of the embodiments of the present invention is to provide an operational method for a terminal device and a terminal device for implementing the operational method, so that a user can rapidly view item information related to a classification item that is presented, thereby improving operational experience of the user.

According to one aspect of the present disclosure, an operational method for a terminal device is provided. The method includes: presenting information of target classification items according to an instruction of presenting the target classification items; and in response to a first press operation of a user on a first classification item in the target classification items, acquiring item information corresponding to the first classification item, and presenting the item information in a form of a floating window.

According to another aspect of the present disclosure, a terminal device is provided. The terminal device includes: at least one processor; and a memory communicably connected with the at least one processor and for storing instructions executable by at least one processor, wherein execution of the instructions by the at least one processor causes the at least one processor to: present on a display information of target classification items according to an instruction of presenting the target classification items; in response to a first press operation of a user on a first classification item in the target classification items, acquire item information corresponding to the first classification item, and present on a display the item information in a form of a floating window.

According to another aspect of the present disclosure, the non-transitory computer-readable storage medium. The non-transitory computer-readable storage medium stores executable instructions that, when executed by a terminal device with a display, cause the terminal device to: present on a display information of target classification items according to an instruction of presenting the target classification items; in response to a first press operation of a user on a first classification item in the target classification items, acquire item information corresponding to the first classification item, and present on the display the item information in a form of a floating window.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a flowchart of an operational method for a terminal device according to some embodiments of the present disclosure;

FIG. 2 shows an exemplary schematic diagram of an interface of a floating window that presents item information in a terminal device;

FIG. 3 shows a flowchart of an operational method for a terminal device according to some embodiments of the present disclosure;

FIG. 4 shows a flowchart of an operational method for a terminal device according to some embodiments of the present disclosure;

FIG. 5 shows a logical block diagram of a terminal device according to some embodiments of the present disclosure;

FIG. 6 shows another logical block diagram of the terminal device according to some embodiments of the present disclosure;

FIG. 7 shows still another logical block diagram of the terminal device according to some embodiments of the present disclosure; and,

FIG. 8 shows a schematic hardware diagram of an electronic apparatus for performing an operational method according to an embodiment of the present disclosure.

### DETAILED DESCRIPTION

An inventive concept of some embodiments of the present disclosure is to provide a solution for rapid preview of item information related to a classification item that is presented, so as to respond to a press operation of a user on a target classification item that is presented, and to present item information corresponding to the classification item in a form of a floating window, so that a user can rapidly view the item information, thereby improving operational experience of the user.

Exemplary embodiments of the present disclosure are described in detail below with reference to the accompanying drawings.

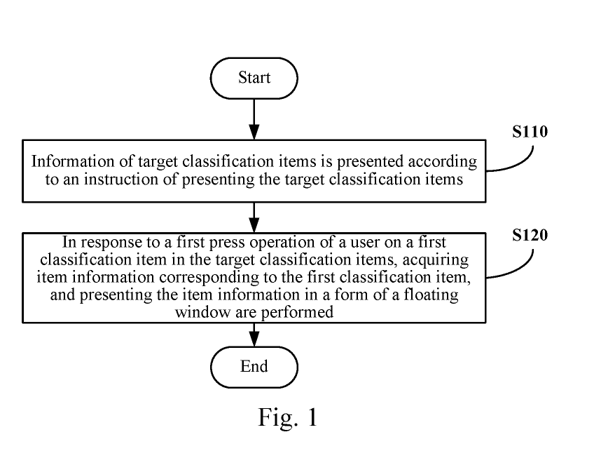

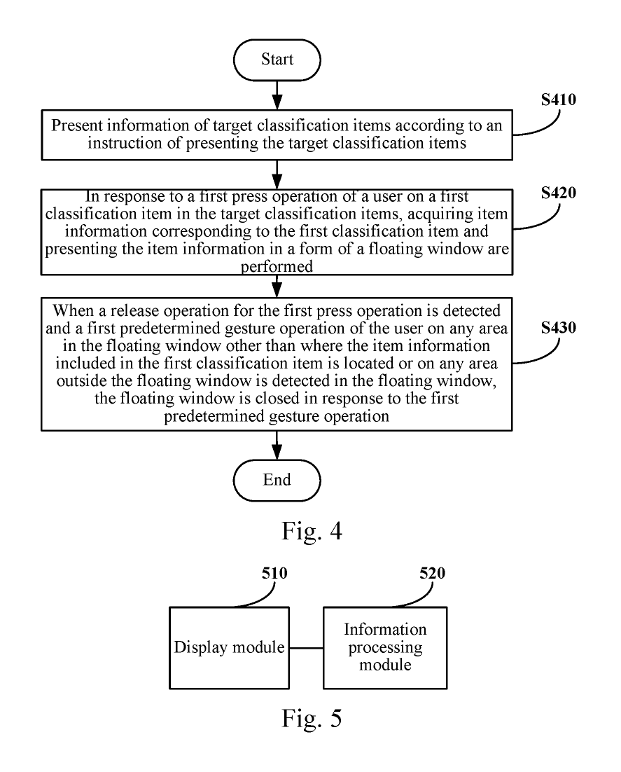

FIG. 1 shows a flowchart of an operational method for a terminal device according to some embodiments of the present disclosure. The operational method is executed by a terminal device shown in FIG. 5.

Referring to FIG. 1, in step S110: Information of target classification items is presented according to an instruction of presenting the target classification items.

The target classification item may be any classification item, For example, classification of movies, classification items thereof may include an action, a horror, and/or a thriller classification item, etc. The terminal device may be a mobile phone, a tablet computer, a smart television or the like.

Specifically, to embody certain regularities or characteristics of a thing, classification may be performed for the thing to classify information of the same regularity or characteristic included in the thing as one category, so as to obtain multiple classification items (which may be target classification items). Classification may further be performed for information in each classification item, so as to obtain all classification items of the thing. For example, movies may be classified in multiple manners. For example, according to the release year of movies, movies may be classified into classification items such as the year of 2015, 2014, 2013, and the like, wherein classification items of each year may further include classification items such as action, comedy and/or war, etc.

When a user needs to search for certain information or a certain type of information, a browser or a corresponding application installed in a terminal device may be used to open a home page of a corresponding resource website. The home page may include multiple classification items related to the information. For example, for movies, classification items may be obtained through classification according to release years or according to emotions conveyed by stories, etc. In this case, the user may tap one of the classification forms, and the terminal device may generate an instruction of presenting a classification item corresponding to the classification form (that is, a target classification item), acquire information of the target classification item, and present the information of the target classification item. The information of the targeted classification item may be presented on a separated page or in a form of drop-down list.

For example, if a user wants to watch an action movie, a home page of a resource website may be opened through the terminal device. The home page may include multiple classification items of movies, and the user may select to use a classification item obtained though classification according to emotions conveyed by stories. In this case, the user may tap a key word of a corresponding type of classification item, and the terminal device may generate an instruction of presenting a target classification item, and present information of the target classification item, such as drama, action, comedy and/or thriller, etc., in a form of a drop-down list.

In Step S120: in response to a first press operation of a user on a first classification item in the target classification items, acquiring item information corresponding to the first classification item, and presenting the item information in a form of a floating window are performed.

The first classification item may be any classification item in the target classification items. The first press operation may be an operation that the user presses an item with a pressure within a preset pressure range for a duration longer than a preset one.

Specifically, the terminal device may include multiple gesture operations such as a tap operation, a press operation, a drag operation, a long-press operation and the like. The tap operation and the long-press operation are both different from the press operation, where the tap operation has a very short operation time, and only requires the user to touch a touch screen of the terminal device without requirements on the pressure with which the user presses the touch screen. To improve operational experience of the user, a pressure sensor may be disposed in the terminal device. The pressure sensor may be disposed in a display component (such as a touch screen, etc.), and is configured to detect a press operation of the user. When the user presses the display component, the pressure sensor can measure the pressure of the press operation of the user. If the pressure falls within a predetermined pressure range, it can be determined that the press operation is effective. In this case, the terminal device can execute processing corresponding to the press operation. Specifically, after the terminal device presents information of the target classification items, if the user needs to search for certain information in any (that is, a first classification item) of the target classification items, a first press operation may be performed on the first classification item. Upon detecting the first press operation, the terminal device sends a request for acquiring item information to a server of a resource website. The server may search, according to a pre-stored correspondence between classification items and item information, for item information corresponding to the first classification item included in the request for acquiring item information. Then, the server may send the item information that is found to the terminal device. The terminal device may pop up a floating window at the position where the user performs the first press operation, and present the item information received from the server in the floating window.

It should be noted that if the item information corresponding to the first classification item has a large data volume, the server may select, according to a preset recommended rule, item information with a predetermined data volume in the item information corresponding to the first classification item, and send the item information with the predetermined data volume to the terminal device. For example, the server may select, in descending order of user ratings on each item information, a predetermined quantity of item information, and send the predetermined quantity of information to the terminal device.

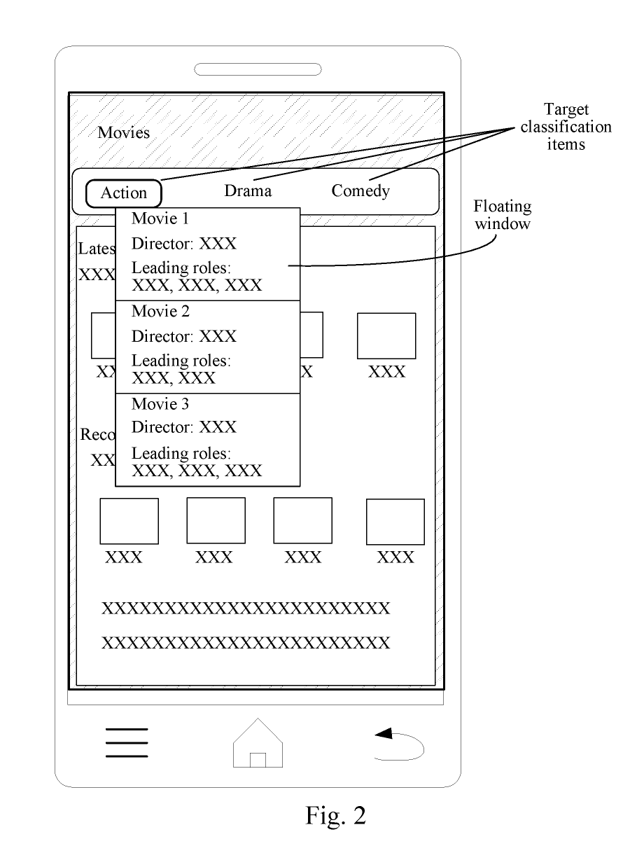

On the basis of the forgoing example of the step S110, as shown in FIG. 2, taking a mobile phone as an example of the terminal device, a user may perform a first press operation on the classification item of “action” (that is, the first classification item). In this case, the terminal device may send a request for acquiring item information to a server, and the server may send movie information (such as the name of a movie, the name of a director and/or the name of a leading role, etc.) included in the classification item of “action” to the terminal device, and the terminal device may pop up a floating window in a preset area where the classification item of “action” is located in the current page, and present in the floating window the movie information received from the server, for example, information of movie 1, information of movie 2, information of movie 3, and information of movie 4 as shown in FIG. 2. If the classification item of “action” includes a large amount of movies information, the server may select, in descending order of user ratings on the movies, a predetermined quantity of movies information and send them to the terminal device.

The operational method for a terminal device that is provided by the embodiment of the present disclosure enables a user to rapidly view item information related to a classification item that is presented, thereby improving operational experience of the user, by presenting the corresponding information according to an instruction of presenting target classification items, acquiring the item information corresponding to the first classification item upon detecting a first press operation of a user on a first classification item in the target classification items, and presenting the item information in a form of a floating window.

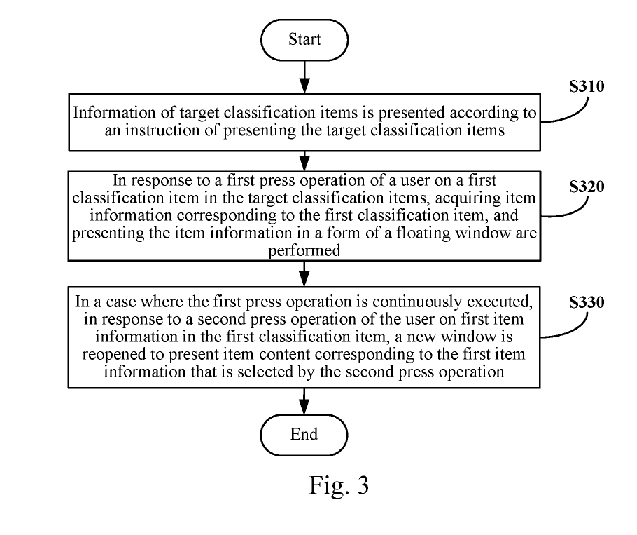

FIG. 3 is a flowchart showing an operational method for a terminal device according to some embodiments of the present disclosure. The embodiments can be considered to be another specific implementation solution of FIG. 1. In the embodiments, a user needs to continuously perform a first press operation to ensure that a flowing window can be normally presented.

Referring to FIG. 3, in Step S310: the information of target classification items is presented according to an instruction of presenting the target classification items.

In Step S320: in response to a first press operation of a user on a first classification item in the target classification items, acquiring item information corresponding to the first classification item, and presenting the item information in a form of a floating window are performed.

The contents of the step S310 and the step S320 are respectively the same as those of the step S110 and the step S120, which are not repeated herein.

It should be noted that in this embodiment, whether the floating window can be normally presented depends on whether the user continuously executes the first press operation.

In Step S330: in a case where the first press operation is continuously executed, in response to a second press operation of the user on first item information in the first classification item, a new window is reopened to present item content corresponding to the first item information selected by the second press operation.

The first press operation may be an operation that the user presses the first classification item with a pressure within a first preset pressure range for a duration longer than a preset one, and the second press operation may be an operation that the user presses the first item information in the first classification item with a pressure within a second preset pressure range. The first press operation and the second press operation correspond to different pressures. To improve operational experience of the user, in this embodiment of the present disclosure, the first press operation may be a light press, and the second press operation may be a heavy press.

Specifically, if the user wants to view certain item information (that is, the first item information) in the first classification item, on the basis of continuously pressing the first classification item, he or she may move the finger that is pressing to a position where the first item information is located. In this case, the user may further press the first item information, on the basis of the pressure applied by the first press operation. The terminal device detects a second press operation of the user on the first item information, and reopens a new window, and presents in the new window the item content such as video content and/or text content corresponding to the first item information.

For example, on the basis of the example in FIG. 2, the user may move the finger that performs the first press operation to an area where “movie 2” (that is, the first item information) is located. Then, the user may further press the area where “movie 2” is located again. The terminal device detects a second press operation of the user on “movie 2”, and reopens a new window, and plays a video corresponding to “movie 2” in the window.

In addition, the user also may close the floating window, and the corresponding processing may include: closing the floating window that presents the item information corresponding to the first classification item, in response to a release operation of the user for the first press operation on the first classification item.

Specifically, in the embodiments, the normal presentation of the floating window depends on that the user continuously executes the first press operation, that is, if the user requires the floating window that presents the item information corresponding to the first classification item to be continuously presented in the current window, he or she may continuously press the window. After finishing the corresponding processing, the user may release the first press operation. In this case, the terminal device closes the floating window. The user may also search other classification items for corresponding item information in the same manner as the foregoing processing manner, until the item information that is needed by the user is found.

The operational method for a terminal device provided by the embodiments of the present disclosure enables a user to rapidly view the item information related to a classification item that is presented and to rapidly access to a page with the item content corresponding to the first item information by the second press operation, thereby improving operational experience of the user, by presenting corresponding information according to an instruction of presenting target classification items; acquiring the item information corresponding to the first classification item upon detecting a first press operation of a user on a first classification item in the target classification items; presenting the item information in a form of a floating window; keeping on continuously pressing the first classification item to ensure continuously displaying the floating window; and presenting in a new window the item content corresponding to the first item information upon detecting a second press operation on the first item information in the floating window.

FIG. 4 is a flowchart showing an operational method for a terminal device according to some embodiments of the present disclosure. The embodiments may be considered to be still another specific implementation solution of FIG. 1. In the embodiments, after a floating window is presented, the user may not need to continuously perform the first press operation, and the floating window can still be normally presented.

Referring to FIG. 4, in Step S410: information of target classification items is presented according to an instruction of presenting the target classification items.

In Step S420: in response to a first press operation of a user on a first classification item in the target classification items, item information corresponding to the first classification item is acquired, and the item information is presented in a form of a floating window.

The step contents of the step S410 and the step S420 are respectively the same as those of the step S110 and the step S120 in the above-described Embodiment 1, and are not repeated herein.

It should be noted that in this embodiment, the continuous normal presentation of a floating window does not depend on that a user continuously executes a first press operation, that is, after a terminal device presents the floating window, the user can stop the first press operation. In this case, the terminal device can still continuously present the floating window.

In Step S430: when a release operation for the first press operation is detected and a first predetermined gesture operation of the user on any area in the floating window other than where the item information included in the first classification item is located or on any area outside the floating window is detected in the floating window, the floating window is closed in response to the first predetermined gesture operation. The first predetermined gesture operation is a tap operation, the first press operation, or the second press operation.

The first press operation and the second press operation correspond to different pressures. To improve operational experience of a user, in this embodiment of the present disclosure, the first press operation may be a light press, and the second press operation may be a heavy press.

Specifically, if a user finishes corresponding processing, the user may return to the page where the floating window is located by a terminal device. The user may perform a first predetermined gesture operation on any area in the floating window other than where the item information included in the first classification item is located or on any area outside the floating window. In this case, the terminal device may close the floating window. The user may also keep on searching other classification items for corresponding item information in the same manner as the forgoing processing manner, until the item information that is needed by the user is found.

In addition, the user may further perform a predetermined gesture operation on certain item information in the floating window, and the corresponding processing may include: when a release operation for the first press operation is detected and a second predetermined gesture operation of the user on the second item information in the first classification item is detected in the floating window, in response to the second predetermined gesture operation, reopening a new window to present the item content corresponding to the second item information that is selected by the second predetermined gesture operation.

Specifically, if the user wants to view certain item information (that is, the second item information) in the first classification item, he or she may tap or press the position where the second item information is located. In this case, the terminal device detects the second predetermined gesture operation of the user on the second item information, and reopens a new window, and presents the item content corresponding to the second item information in the new window.

It should be noted that, a predetermined gesture operation may be a tap operation, the first press operation, or the second press operation. In this embodiment, the second predetermined gesture operation on certain item information may be the same as the first predetermined gesture operation for closing the floating window. In another embodiment of the present disclosure, the two gesture operations may be different. To avoid confusion, different names are assigned to the two gesture operations, that is, the predetermined gesture operation in the step S430 is referred to as a first predetermined gesture operation, and a predetermined gesture operation on certain item information is referred to as a second predetermined gesture operation.

The operational method for a terminal device provided by the embodiments of the present disclosure enables a user to rapidly view the item information related to a classification item that is presented, thereby improving operational experience of the user, by presenting corresponding information according to an instruction of presenting target classification items; acquiring the item information corresponding to the first classification item upon detecting a first press operational of a user on a first classification item in the target classification items; presenting the item information in a form of a floating window where continuous display of the floating window can be ensured without the need to continuously press the window; and closing the floating window when a predetermined gesture operational on any area in the floating window other than where the item information included in the first classification item is located or on any area outside the floating window is detected in the floating window.

On the basis of the same technical concept, FIG. 5 is a logical block diagram showing a terminal device according to some embodiments of the present disclosure. Referring to FIG. 5, the terminal device includes a display module 510 and an information processing module 520.

The display module 510 is configured to present information of target classification items according to an instruction of presenting the target classification items.

The information processing module 520 is configured to acquire item information corresponding to the first classification item in response to a first press operational of a user on a first classification item in the target classification items, and to present the item information in a form of a floating window.

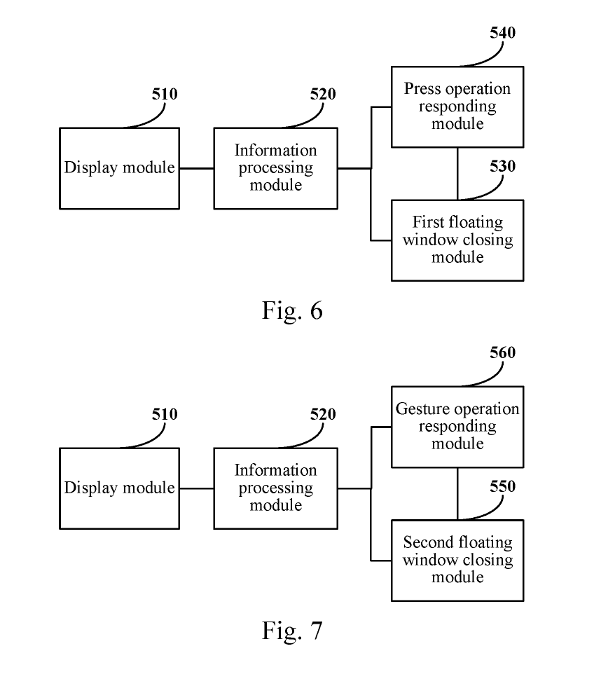

Further, on the basis of the embodiments shown in FIG. 5, a terminal device shown in FIG. 6 further includes: a first floating window closing module 530 configured to close the floating window that presents the item information corresponding to the first classification item, in response to a release operational of the user for the first press operational on the first classification item.

Further, the terminal device shown in FIG. 6 further includes: a press operational responding module 540 configured to reopen a new window to present item content corresponding to the first item information that is selected by the second press operational, in a case where the first press operational is continuously executed, in response to a second press operational of the user on first item information in the first classification item.

Further, on the basis of the embodiments shown in FIG. 5, a terminal device shown in FIG. 7 further includes: a second floating window closing module 550 configured to close the floating window when the release operational for the first press operational is detected and a first predetermined gesture operational of the user on any area in the floating window other than where the item information included in the first classification item is located or on any area outside the floating window is detected in the floating window, in response to the first predetermined gesture operation, where the first predetermined gesture operation is a tap operation, the first press operation, or the second press operation, and the first press operation is an operation that the user presses the first classification item with a pressure within a first preset pressure range for a duration longer than a preset one, and the second press operation is an operation that the user presses the first item information in the first classification item with a pressure within a second preset pressure range.

Further, the terminal device shown in FIG. 7 further includes: a gesture operation responding module 560 configured to reopen a new window to present item content corresponding to the second item information that is selected by the second predetermined gesture operation, when the release operation for the first press operation is detected and a second predetermined gesture operation of the user on the second item information in the first classification item is detected in the floating window, in response to the second predetermined gesture operation, where the second predetermined gesture operation is a tap operation, the first press operation, or the second press operation, and the first press operation is an operation that the user presses the first classification item with a pressure within a first preset pressure range for a duration longer than a preset one, and the second press operation is an operation that the user presses the second item information in the first classification item with a pressure within the second preset pressure range.

The terminal device provided by the embodiments of the present disclosure enables a user to rapidly view item information related to a classification item that is presented, thereby improving operational experience of the user, by presenting corresponding information according to an instruction of presenting target classification items, and acquiring item information corresponding to the first classification item upon detecting a first press operation of a user on a first classification item in the target classification items, and presenting the item information in a form of a floating window.

Further, in this embodiment of the present disclosure, continuous display of the floating window can be maintained through continuous pressing on a window or in other manners, and corresponding processing is executed when a predetermined gesture operation on the first classification item or on other areas in the floating window is detected, thereby further improving operational experience of the user.

According to an embodiment of the present disclosure, there is provided with a non-transitory computer-readable storage medium storing executable instructions that, when executed by an electronic device with a touch-sensitive display, cause the electronic device to perform any of the above disclosed methods.

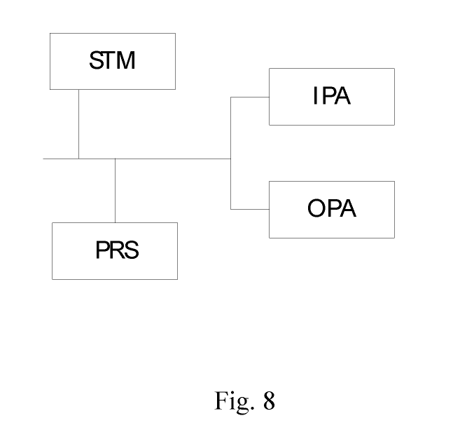

FIG. 8 illustrates a schematic hardware diagram of an electronic apparatus for performing an operational method according to an embodiment of the present disclosure. According to FIG. 8, the electronic apparatus includes: one or more processors PRS and a storage medium STM. By way of example, FIG. 8 shows one processor PRS.

The electronic apparatus can further include an input apparatus IPA and an output apparatus OPA.

The one or more processors PRS, storage medium STM and output apparatus OPA may be connected by a bus or other means. By way of example, FIG. 8 shows a bus for connection.

Storage medium STM is a non-transitory computer-readable medium for storing a non-transitory software program, a non-transitory computer-readable program and module, for example the program instructions/module for an operational method (such as, information processing module 520, press operation responding module 540 and first floating window closing module 530 shown in FIG. 6). The processor PRS can operate the various functions and data processing of a server to perform an operational method described in the above embodiments by executing non-transitory software programs, instructions and modules stored in the storage medium STM.

The storage medium STM can include a program storage area and a data storage area. Among them, the program storage area may store operational system, application programs of at least one function; the data storage area may store generated data during operational of the electronic apparatus for performing the method described in the above embodiments. In addition, the storage medium STM may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRS. The remote storage medium may be connected to the electronic apparatus for performing any of the above methods by a network. The examples of such as network include but not limited to Internet, enterprise intranet, local area network, mobile telecommunication network and a combination thereof.

The input apparatus IPA can receive input number or byte information, and can generate input key information relating to user setting and functional control of the electronic apparatus for performing the method described in the above embodiments. The output apparatus OPA may include a display device such as a display screen.

The one or more modules stored in the storage medium STM that, when executed by the one or more processors PRS, can perform any of the above described methods.

The above products can perform any of the above described methods, and have corresponding functional modules and effects. Details that are not disclosed in this embodiment can be understood by reference to the above method embodiments of the present disclosure.

An electronic apparatus of the present disclosure can exist in a varied form and includes but not limited to:
(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.
(2) A super-mobile personal computer which belongs to the field of a personal computer and has calculation and processing functions, and in general can access to a mobile network. Such a terminal device includes: a PDA, a MID and a UMPC etc., for example iPad.
(3) A portable entertainment device which is capable of displaying and playing multimedia content. Such a device includes: an audio player, a video player (e.g. iPod), a handheld game console, an electronic book, a smart toy and a portable automotive navigation device.
(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.
(5) Other electronic apparatus that is capable of data exchange.

The above described apparatus embodiments are for illustration purpose only, in which units that are described above as separate elements may be physically separate or not separate and units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

The previous embodiments are provided to enable any person skilled in the art to practice the various embodiments of the present disclosure described herein but not to limit these aspects. Though the present disclosure is described by reference to the previous embodiments, various modifications and equivalent features will be readily apparent to those skilled in the art without departing from the spirit and scope of the present disclosure, and the generic principles defined herein may be applied to other aspects or with equivalent features. Thus, the claims are not intended to be limited to the aspects and features shown herein, but are to be accorded the full scope consistent with the language of the claims.

It should be noted that according to the needs of implementations, each step/part described in this application may be divided into more steps/parts, and also two or more steps/parts or some operations of steps/parts may be combined into a new step/part, so as to achieve the objective of the present disclosure.

The foregoing method according to the present disclosure may be implemented in hardware or firmware, or may be implemented as software or computer code that can be stored in a recording medium (for example, a CD ROM, a RAM, a floppy disk, a hard disk or a magneto-optical disc), or may be implemented as computer code downloaded from a network that is originally stored in a remote recording medium or a non-transitory machine readable medium and will be stored in a local recording medium. Accordingly, the method described herein can be processed by such a software that is stored in a recording medium that uses a general-purpose computer, a special-purpose processor or programmable or special-purpose hardware (for example, an ASIC or an FPGA). It may be understood that a computer, a processor, a microprocessor controller or programmable hardware includes a storage component (for example, a RAM, a ROM, and a flash memory, etc.) that can store or receive software or computer code. When the software or computer code is accessed and executed by the computer, the processor or the hardware, the processing method described herein is implemented. In addition, when the general-purpose computer accesses the code that is used for implementing processing shown herein, the execution of the code converts the general-purpose computer to a special-purpose computer configured to execute the processing shown herein.

The foregoing descriptions are merely specific implementation manners of the present disclosure, but the protection scope of the present disclosure is not limited thereto. Any variation or replacement that can be readily conceived of by a person skilled in the art within the technical scope of the present disclosure should fall within the protection scope of the present disclosure. Therefore, the protection scope of the present disclosure should be defined by the claims.

What is claimed is:

1. An operational method for a terminal device, comprising:
presenting information of target classification items according to an instruction of presenting the target classification items; and
in response to a first press operation of a user on a first classification item in the target classification items, acquiring item information corresponding to the first classification item, and presenting the item information in a form of a floating window.

2. The operational method according to claim 1, wherein the operational method further comprises:
in response to a release operation of the user for the first press operation on the first classification item, closing the floating window that presents the item information corresponding to the first classification item.

3. The operational method according to claim 1, wherein the operational method further comprises:
in a case that the first press operation is continuously executed, in response to a second press operation of the user on first item information in the first classification item, reopening a new window to present item content corresponding to the first item information selected by the second press operation;
wherein the first press operation is an operation that the user presses the first classification item with a pressure within a first preset pressure range for a duration longer than preset duration, and the second press operation is an operation that the user presses the first item information in the first classification item with a pressure within a second preset pressure range.

4. The operational method according to claim 1, wherein the operational method further comprises:
when a release operation for the first press operation is detected and a first predetermined gesture operation of the user on any area in the floating window other than where the item information included in the first classification item is located or on any area outside the floating window is detected, closing the floating window in response to the first predetermined gesture operation,
wherein the first predetermined gesture operation is a tap operation, the first press operation, or the second press operation, and the first press operation is an operation that the user presses the first classification item with a pressure within a first preset pressure range for a duration longer than a preset duration, and the second press operation is an operation that the user presses the first item information in the first classification item with a pressure within a second preset pressure range.

5. The operational method according to claim 1, wherein the operational method further comprises:
when the release operation for the first press operation is detected and a second predetermined gesture operation of the user on a second item information in the first classification item is detected in the floating window, in response to the second predetermined gesture operation, reopening a new window to present item content corresponding to the second item information that is selected by the second predetermined gesture operation,
wherein the second predetermined gesture operation is a tap operation, the first press operation, or the second press operation, and the first press operation is an operation that the user presses the first classification item with a pressure within a first preset pressure range for a duration longer than a preset one, and the second press operation is an operation that the user presses the second item information in the first classification item with a pressure within the second preset pressure range.

6. A terminal device, comprising:
at least one processor; and,
a memory communicably connected with the at least one processor and for storing instructions executable by at least one processor, wherein execution of the instructions by the at least one processor causes the at least one processor to:
present on a display information of target classification items according to an instruction of presenting the target classification items;
in response to a first press operation of a user on a first classification item in the target classification items, acquire item information corresponding to the first classification item, and
present on a display the item information in a form of a floating window.

7. The terminal device according to claim 6, wherein the at least one processor is further caused to:
in response to a release operation of the user for the first press operation on the first classification item, close on the display the floating window that presents the item information corresponding to the first classification item.

8. The terminal device according to claim 6, wherein the at least one processor is further caused to:
in response to a second press operation of the user on first item information in the first classification item, reopen on the display a new window to present item content corresponding to the first item information that is selected by the second press operation in a case where the first press operation is continuously executed,
wherein the first press operation is an operation that the user presses the first classification item with a pressure within a first preset pressure range for a duration longer than a preset one, and the second press operation is an operation that the user presses the first item information in the first classification item with a pressure within a second preset pressure range.

9. The terminal device according to claim 6, wherein the at least one processor is further caused to:
in response to the first predetermined gesture operation, close on the display the floating window when the release operation for the first press operation is detected and a first predetermined gesture operation of the user on any area in the floating window other than where the item information included in the first classification item is located or on any area outside the floating window is detected in the floating window,
wherein the first predetermined gesture operation is a tap operation, the first press operation, or the second press operation, and the first press operation is an operation that the user presses the first classification item with a pressure within a first preset pressure range for a duration longer than a preset one, and the second press operation is an operation that the user presses the first item information in the first classification item with a pressure within a second preset pressure range.

10. The terminal device according to claim 6, wherein at least one processor is further caused to:
in response to the second predetermined gesture operation, reopen on the display a new window to present item content corresponding to the second item information that is selected by the second predetermined gesture operation when the release operation for the first press operation is detected and a second predetermined gesture operation of the user on the second item information in the first classification item is detected in the floating window,
wherein the second predetermined gesture operation is a tap operation, the first press operation, or the second press operation, and the first press operation is an operation that the user presses the first classification item with a pressure within a first preset pressure range for a duration longer than a preset one, and the second press operation is an operation that the user presses the second item information in the first classification item with a pressure within the second preset pressure range.

11. A non-transitory computer-readable storage medium storing executable instructions that, when executed by a terminal device with a display, cause the terminal device to:
present on a display information of target classification items according to an instruction of presenting the target classification items;
in response to a first press operation of a user on a first classification item in the target classification items, acquire item information corresponding to the first classification item, and present on the display the item information in a form of a floating window.

12. The non-transitory computer-readable storage medium of claim 11, wherein the storage medium further comprises instructions to:
in response to a first press operational of a user on a first classification item in the target classification items, acquire item information corresponding to the first classification item, and
present on the display the item information in a form of a floating window.

13. The non-transitory computer-readable storage medium of claim 11, wherein the storage medium further comprises instructions to:
in response to a release operational of the user for the first press operational on the first classification item, close the floating window that presents the item information corresponding to the first classification item.

14. The non-transitory computer-readable storage medium of claim 11, wherein the storage medium further comprises instructions to:
in response to a second press operational of the user on first item information in the first classification item, reopen on the display a new window to present item content corresponding to the first item information that is selected by the second press operation in a case where the first press operation is continuously executed,
wherein the first press operation is an operation that the user presses the first classification item with a pressure within a first preset pressure range for a duration longer than a preset one, and the second press operation is an operation that the user presses the first item information in the first classification item with a pressure within a second preset pressure range.

15. The non-transitory computer-readable storage medium of claim 11, wherein the storage medium further comprises instructions to:
in response to the first predetermined gesture operation, close on the display the floating window when the release operation for the first press operation is detected and a first predetermined gesture operation of the user on any area in the floating window other than where the item information included in the first classification item is located or on any area outside the floating window is detected in the floating window,
wherein the first predetermined gesture operation is a tap operation, the first press operation, or the second press operation, and the first press operation is an operation that the user presses the first classification item with a pressure within a first preset pressure range for a duration longer than a preset one, and the second press operation is an operation that the user presses the first item information in the first classification item with a pressure within a second preset pressure range.

16. The non-transitory computer-readable storage medium of claim 11, wherein the storage medium further comprises instructions to:
in response to the second predetermined gesture operation, reopen on the display a new window to present item content corresponding to the second item information that is selected by the second predetermined gesture operation when the release operation for the first press operation is detected and a second predetermined gesture operation of the user on the second item information in the first classification item is detected in the floating window;
wherein the second predetermined gesture operation is a tap operation, the first press operation, or the second press operation, and the first press operation is an operation that the user presses the first classification item with a pressure within a first preset pressure range for a duration longer than a preset one, and the second press operation is an operation that the user presses the second item information in the first classification item with a pressure within the second preset pressure range.
